(19) United States
(12) Patent Application Publication
(10) Pub. No.: US 2026/0364522 A1
(43) Pub. Date: Nov. 19, 2026

(54) DEGASIFICATION SYSTEM AND METHODS THEREOF FOR REMOVING TARGET GAS FROM RAW MEDIUM

(71) Applicant: Landingways Group Ltd., Woburn, MA (US)

(72) Inventors: Joshua Hongbo Wei, Troy, NY (US); Hongji Wei, Cambridge, MA (US)

(73) Assignees: Landingways Group Ltd, Woburn, MA (US); Landingways Group Ltd., Woburn, MA (US)

(21) Appl. No.: 19/207,362

(22) Filed: May 14, 2025

(51) Int. Cl. B01D 53/14; B01D 53/18; B01D 53/26

(52) U.S. Cl. CPC B01D 53/1425; B01D 53/1412; B01D 53/1475; B01D 53/185; B01D 53/265; B01D 2257/504

(57) ABSTRACT

The present invention provides a degasification system and a method for removing target gases such as CO₂, SO₂, COS and CS₂ from waste gases using and reusing a liquid molecular sieve solution. Two or more heat exchangers are used for sufficiently exchanging heat between a liquid rich in the target gases and a liquid lean in the target gases. A vacuum regeneration tower may be used in addition to a steaming regeneration tower. A reflux sub-system may be mounted onto each of the towers. The invention exhibits numerous technical merits such as simple operation, cost-effectiveness, high product purity, and improved efficiency in removing target gases, among others.

### CROSS REFERENCE TO RELATED APPLICATIONS

Not applicable.

### FIELD OF THE INVENTION

The present invention generally relates to a degasification system and methods using the degasification system for removing a target gas from a raw medium with a processing liquid which can be spent, regenerated, recycled, and reused in the system. A representative embodiment relates to the field of gas decarbonization in industry, specifically to processes and equipment for the decarbonization of flue gas, various combustion exhaust (waste) gases, industrial feed gases, and industrial waste gases. Although the invention will be illustrated, explained and exemplified by removing target gas CO₂ from waste gases using a liquid molecular sieve solution, it should be appreciated that the present invention can also be applied to other fields, for example, removing other target gases such as SO₂ from flue gas, COS and CS₂ from industrial feed gases, such as water gas, semi-water gas, shift gas, coke oven gas, blast furnace gas, natural gas, biogas, and the like.

### BACKGROUND OF THE INVENTION

Emissions of gases such as CO₂, SO₂, COS and CS₂ become a concern for the protection of our environment. For example, the combustion of fossil fuels generates large amounts of flue gas emissions released into the atmosphere, which contains sulfur dioxide (SO₂), sulfur trioxide (SO₃), hydrogen chloride (HCl), hydrogen fluoride (HF), nitrogen oxides (NOₓ), small amounts of harmful organic substances, and dust. The fine hydrophilic and non-hydrophilic particles in the dust (mainly calcium salts, aluminum salts, magnesium salts, titanium salts, iron salts, lead salts, zinc salts, cobalt salts, rare earth element particles, radioactive element particles, and other harmful elemental particles, as well as mineral particles like silica, mullite, silicates, and phosphates) are discharged into the atmosphere together with the flue gas. These particles can easily absorb harmful substances like sulfur dioxide, sulfur trioxide, hydrogen chloride, hydrogen fluoride, nitrogen oxides, organic compounds, and bacteria on their surface, leading to the significant increase of atmospheric suspended particles (or called aerosol particles, commonly referred to as PM100, PM10, PM2.5, and so on). This leads to the formation of smog and atmospheric photochemical reactions, causing severe environmental pollution.

At the same time, a large amount of carbon dioxide (CO₂) is released into the atmosphere. When the rate at which biological systems (including plants, animals, microorganisms, etc.) consume CO₂ is lower than the rate of CO₂ emissions, the concentration of CO₂ in the atmosphere increases year by year, leading to the greenhouse effect. This disrupts the biosphere and causes the extinction of many species. According to the NOAA Global Monitoring Laboratory's annual report, the global average CO₂ concentration reached a record high of 419.3 ppm in 2023. NASA data shows that, in April 2024, the average CO₂ concentration reached 426.57 ppm. The concentration of CO₂ in the atmosphere is rising continuously, and if this trend continues, human survival will face great threats, potentially even leading to human extinction. Therefore, reducing industrial CO₂ emissions is imperative. The first key step in reducing industrial CO₂ emissions is decarbonization (also known as “carbon capture”), followed by carbon storage and carbon utilization.

Today, the technology for capturing carbon dioxide from flue gas and waste gases is still in its early stage. There is not truly economically viable and stable method with high decarbonization efficiency. In industrial production processes, there are many methods and technologies for decarbonizing industrial feed gases. However, these methods and processes generally require pressurized conditions for absorption, and energy consumption during the absorption process is extremely high. At the same time, they can only be regenerated under heating and depressurization conditions, which require very high temperatures and result in significant steam consumption, leading to very high operating costs. As a result, these technologies and processes in the prior art cannot be effectively applied to the decarbonization of flue gases and waste gases.

Therefore, there exists a need to overcome the problems as described above. Advantageously, the present invention provides a degasification system and methods using the degasification system for removing a target gas from a raw medium in a simple, cost-effective, and energy efficient way. For example, a new process and equipment for gas decarbonization as an embodiment of the present invention can solve the problems of high steam and electricity consumption. The embodiment exhibits numerous technical merits such as simple operation, cost-effectiveness, high product purity, and improved efficiency in removing target gases, among others.

### SUMMARY OF THE INVENTION

One aspect of the present invention provides a degasification system for removing a target gas from a raw medium with a processing liquid while regenerating/recycling the processing liquid. The degasification system typically includes a degasification tower, a steaming regeneration tower, a rich liquid channel, a lean liquid channel, and one, two or more heat exchangers. The degasification tower may be e.g. a decarbonization tower and configured for receiving the raw medium containing the target gas and a lean liquid as the processing liquid. In the degasification tower, the lean liquid contacts the raw medium, absorbs the target gas in the raw medium, and it is then converted into a rich liquid loaded with the target gas. The steaming regeneration tower may be configured for receiving a stripping steam and the rich liquid loaded with the target gas from the degasification tower. In the steaming regeneration tower, the stripping steam contacts the rich liquid, strips the target gas away from the rich liquid, and converts the rich liquid to a lean liquid for reusing in the degasification tower. Through the rich liquid channel, the rich liquid can flow from the degasification tower to the steaming regeneration tower. Through the lean liquid channel, the lean liquid can flow from the steaming regeneration tower back to the degasification tower. The one, two or more heat exchangers may be placed along both the rich liquid channel and the lean liquid channel and configured for heating the rich liquid while cooling the lean liquid. In preferred embodiments, the degasification system further comprises a sub-system for collecting and recycling the target gas that is separated from the raw medium.

Another aspect of the invention provides a process of removing a target gas (such as CO₂, SO₂, COS and CS₂) from a raw medium using the degasification system as described above. The process may include steps of (i) providing a liquid molecular sieve solution; (ii) using the liquid molecular sieve solution as the processing liquid in the degasification system as described above; and (iii) reducing or eliminating the target gas in the raw medium using the degasification system as described above. In preferred embodiments, the process further comprises a step of collecting and recycling the target gas that is separated from the raw medium.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form, omitted, or merely suggested, in order to avoid unnecessarily obscuring the present invention.

FIG. 1 schematically shows a degasification system for removing a target gas with a processing liquid in accordance with an exemplary embodiment of the present invention.

FIG. 2 illustrates a degasification system with a vacuum regeneration tower for further removing residual target gas in accordance with an exemplary embodiment of the present invention.

FIG. 3 illustrates a reflux sub-system mounted onto a steaming regeneration tower in accordance with an exemplary embodiment of the present invention.

FIG. 4 illustrates a reflux sub-system mounted onto a steaming regeneration tower in accordance with another exemplary embodiment of the present invention.

FIG. 5 schematically shows two reflux sub-systems mounted onto both the steaming regeneration and the vacuum regeneration tower in accordance with an exemplary embodiment of the present invention.

FIG. 6 schematically shows a reflux sub-system mounted onto the vacuum regeneration tower but not onto the steaming regeneration tower in accordance with an exemplary embodiment of the present invention.

FIG. 7 schematically shows a degasification system with two heat exchangers and two reflux sub-systems in accordance with an exemplary embodiment of the present invention.

FIG. 8 schematically shows the details of a reflux sub-system mounted onto the steaming regeneration in accordance with an exemplary embodiment of the present invention.

FIG. 9 schematically shows the details of two reflux sub-systems in accordance with an exemplary embodiment of the present invention.

FIG. 10 schematically illustrates the details of a degasification system without a vacuum regeneration tower in accordance with an exemplary embodiment of the present invention.

FIG. 11 schematically illustrates the details of a degasification system with a vacuum regeneration tower in accordance with an exemplary embodiment of the present invention.

FIG. 12 is the flow chart of a process of removing a target gas (such as CO₂, SO₂, COS and CS₂) from a raw medium in accordance with an exemplary embodiment of the present invention.

FIG. 13 schematically illustrates the details of a comparative degasification system without a vacuum regeneration tower and without a reflux sub-system.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), +0.5% (inclusive), +1% (inclusive) of that numeral, +2% (inclusive) of that numeral, +3% (inclusive) of that numeral, +5% (inclusive) of that numeral, +10% (inclusive) of that numeral, or +15% (inclusive) of that numeral. It should further be appreciated that when a numerical range is disclosed herein, any numerical value falling within the range is also specifically disclosed.

As used herein, “free” or “substantially free” of a material may refer to a composition, component, or phase where the material is present in an amount of less than 10.0 weight %, less than 5.0 weight %, less than 3.0 weight %, less than 1.0 weight %, less than 0.1 weight %, less than 0.05 weight %, less than 0.01 weight %, less than 0.005 weight %, or less than 0.0001 weight % based on a total weight of the composition, component, or phase.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

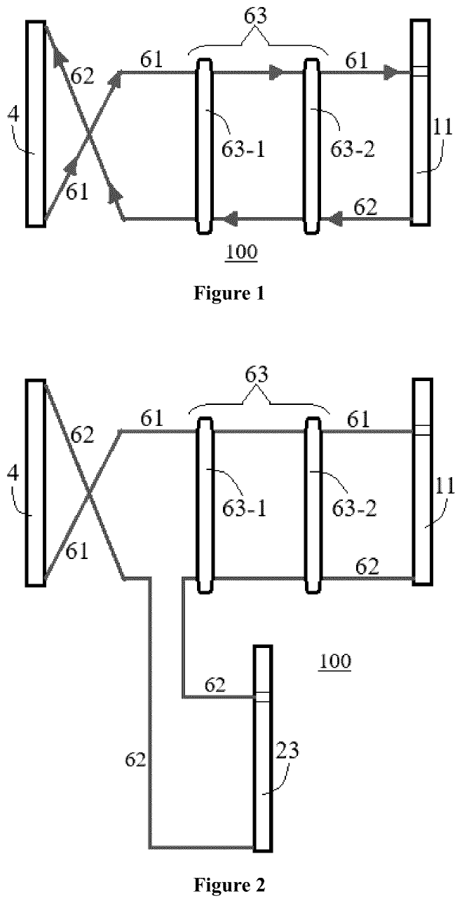

As schematically illustrated in FIG. 1, various embodiments of the invention provide a degasification system 100 for removing a target gas from a raw medium with a processing liquid while regenerating/recycling the processing liquid. The degasification system 100 typically includes a degasification tower 4, a steaming regeneration tower 11, a rich liquid channel 61, a lean liquid channel 62, and one, two or more heat exchangers 63.

The degasification tower 4 may be e.g. a decarbonization tower and configured for receiving the raw medium containing the target gas and a lean liquid employed as the processing liquid. In the degasification tower 4, the lean liquid contacts the raw medium, absorbs the target gas in the raw medium, and itself is then converted into a rich liquid loaded with the target gas. The steaming regeneration tower 11 may be configured for receiving a stripping steam (E) and the rich liquid loaded with the target gas from the degasification tower 4. In the steaming regeneration tower 11, the stripping steam contacts the rich liquid and strips the target gas away from the rich liquid, thus converting the rich liquid to a lean liquid for reusing in the degasification tower 4.

Through the rich liquid channel 61, the rich liquid can flow from the degasification tower 4 to the steaming regeneration tower 11. Through the lean liquid channel 62, the lean liquid can flow from the steaming regeneration tower 11 back to the degasification tower 4.

One, two or more heat exchangers 63 (such as 63-1, 63-2 . . . ) may be placed along both the rich liquid channel 61 and the lean liquid channel 62 and configured for heating the rich liquid while cooling the lean liquid simultaneously. In preferred embodiments, the degasification system 100 further comprises a sub-system (not shown) for collecting and recycling the target gas separated from the raw medium.

In some embodiments as shown in FIG. 2, the degasification system 100 may further include a vacuum regeneration tower 23 for further removing residual target gas from the lean liquid flowing out directly from the steaming regeneration tower 11 or flowing out directly from any of the one, two or more heat exchangers 63 (such as 63-1, 63-2 . . . ). In the vacuum regeneration tower 23, the lean liquid may be upgraded to a higher grade before it flows to the degasification tower 4.

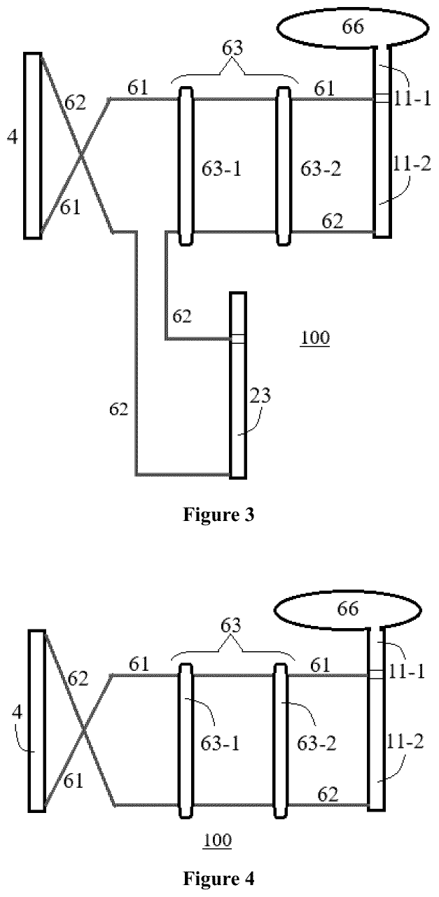

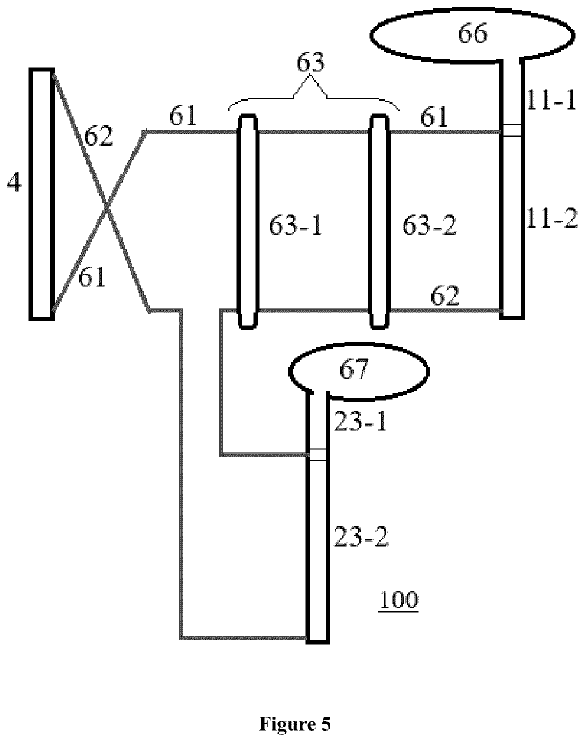

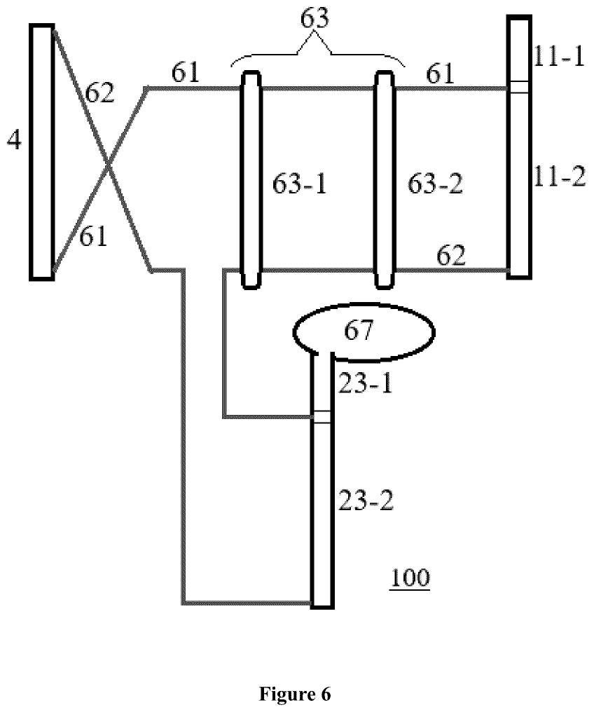

The degasification system 100 may include a first reflux sub-system 66 mounted onto an upper segment 11-1 of the steaming regeneration tower 11, along with the vacuum regeneration tower 23, as shown in FIG. 3, or not, as shown in FIG. 4. A second reflux sub-system 67 may be mounted to an upper segment 23-1 of the vacuum regeneration tower 23, along with the first reflux sub-system 66, as shown in FIG. 5, or not, as shown in FIG. 6.

In a preferred embodiment as shown in FIG. 5, the degasification system 100 includes a first reflux sub-system 66 mounted onto an upper segment 11-1 of the steaming regeneration tower 11 and a second reflux sub-system 67 mounted to an upper segment 23-1 of the vacuum regeneration tower 23. The first reflux sub-system 66 and the steaming regeneration tower 11 may be built together into a single-tower structure. Similarly, the second reflux sub-system 67 and the vacuum regeneration tower 23 may be built together into a single-tower structure.

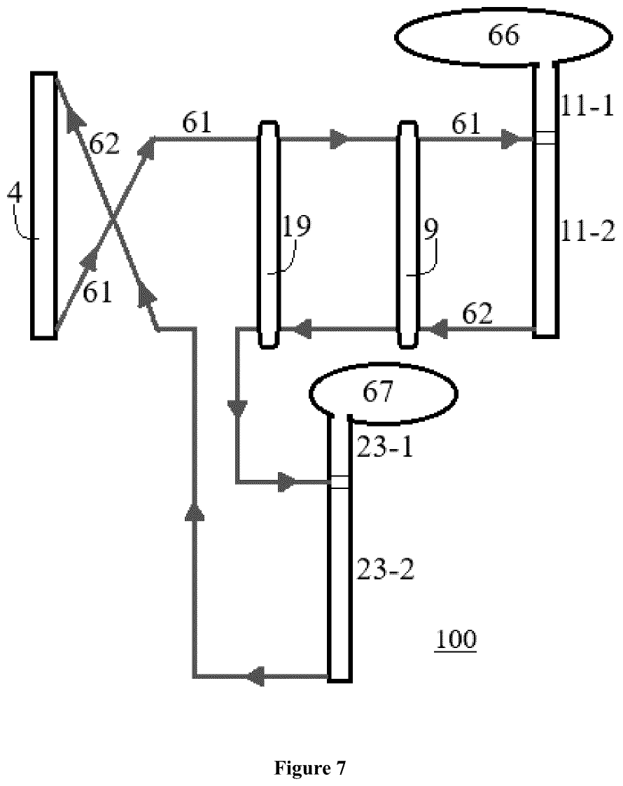

Referring to an exemplary degasification system 100 as shown in FIG. 7, the one, two or more heat exchangers 63 may include a first heat exchanger 19 and a second heat exchanger 9. The first heat exchanger 19 is configured for (A) heating the rich liquid from the degasification tower 4 before the rich liquid flows into the second heat exchanger 9, and (B) cooling the lean liquid from the second heat exchanger 9 before the lean liquid flows back into the degasification tower 4. In contrast, the second heat exchanger 9 is configured for (A) heating the rich liquid from first heat exchanger 19 before the rich liquid flows into the steaming regeneration tower 11, and (B) cooling the lean liquid from the steaming regeneration tower 11 before the lean liquid flows into the first heat exchanger 19.

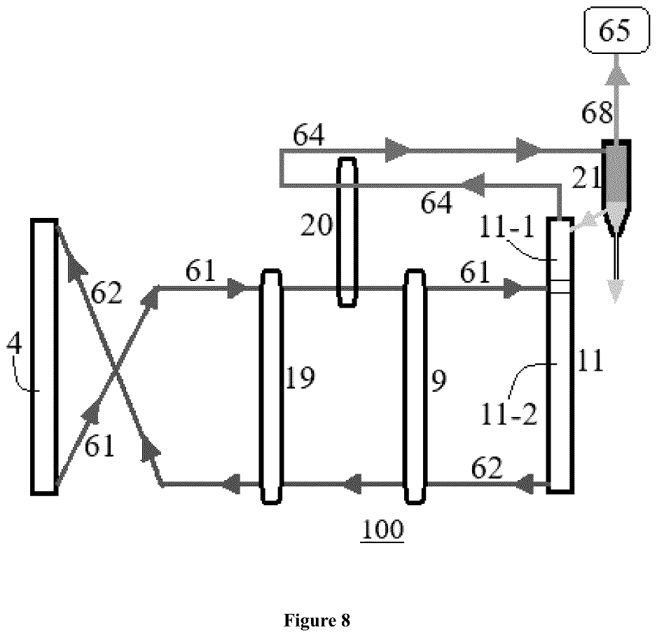

Focusing on the first reflux sub-system 66, it may include a reflux heat exchanger 20. As shown in FIG. 8, the reflux heat exchanger 20 may be placed along the rich liquid channel 61 only (i.e. not along the poor liquid channel 62). The reflux heat exchanger 20 may be located between the first heat exchanger 19 and the second heat exchanger 9. The reflux heat exchanger 20 is configured for further heating the rich liquid from the first heat exchanger 19 before the rich liquid flows into the second heat exchanger 9.

The steaming regeneration tower 11 may produce a hot blend of the target gas and a vapor at its upper segment 11-1. The first reflux sub-system 66 may thus include a hot blend channel 64. The hot blend releases/flows into the reflux heat exchanger 20 through the hot blend channel 64 for heating the rich liquid flowing within the rich liquid channel 61 that is inside the reflux heat exchanger 20 while cooling the hot blend itself, as shown in FIG. 8.

The first reflux sub-system 66 includes a first demister 21. The hot blend from the reflux heat exchanger 20 enters the first demister 21, and separates into a gas phase containing the target gas and a liquid phase containing condensed water and possibly an active ingredient. At least a part of the liquid phase can flow back (if needed) into the steaming regeneration tower 11 through an inlet located on its upper segment 11-1.

The degasification system as shown in FIG. 8 may include a first target gas processing sub-system 65 for collecting and disposing of the target gas in the gas phase from the first demister 21. The first reflux sub-system 66 may include a first gas channel 68 designed for the gas phase to flow from the first demister 21 into the first target gas processing sub-system 65.

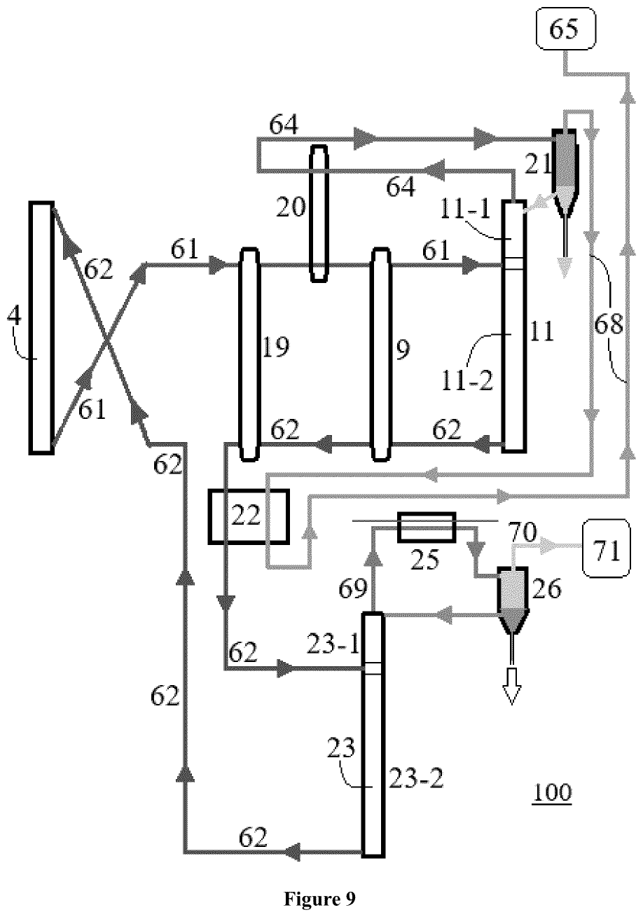

Referring to FIG. 9, a pre-vacuum heater 22 may be placed along the lean liquid channel 62 only and configured for heating the lean liquid that has been cooled by the first heat exchanger 19, before the lean liquid flows into vacuum regeneration tower 23. The pre-vacuum heater 22 may be configured as a heat exchanger. The gas phase containing the target gas in the first gas channel 68 may be used in the pre-vacuum heater 22 to heat the lean liquid from the first heat exchanger 19, before it is introduced into the first target gas processing sub-system 65 for collecting and disposing of the target gas therein.

Referring again to FIG. 9, the second reflux sub-system 67 may include a reflux cooler 25, a second demister 26, a warm mixture channel 69, and a second gas channel 70 connecting to a second target gas processing sub-system 71. The vacuum regeneration tower 23 may produce a warm gas mixture at its upper segment 23-1. The reflux cooler 25 is configured for cooling the warm gas mixture flowing in the warm mixture channel 69 using any suitable cooling source such as tap water or condensed cold water. The warm gas mixture that has been cooled by the reflux cooler 25 enters the second demister 26 and separates into a gas phase containing the target gas and a liquid phase containing condensed water and possibly an active ingredient. At least a part of the liquid phase can flow back (if needed) into the vacuum regeneration tower 23 on its upper segment 23-1. The gas phase containing the target gas in the second demister 26 is released into the second target gas processing sub-system 71 along the second gas channel 70 for collecting and disposing of the target gas in the gas phase.

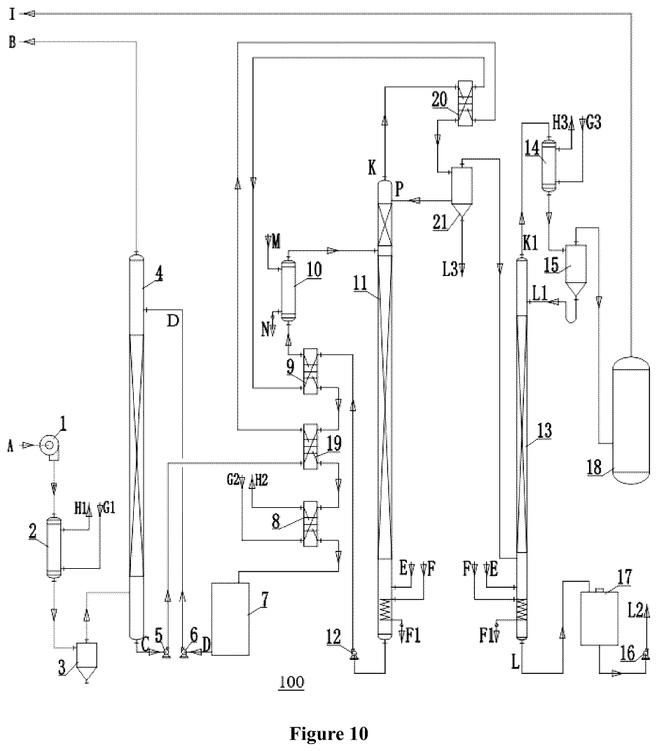

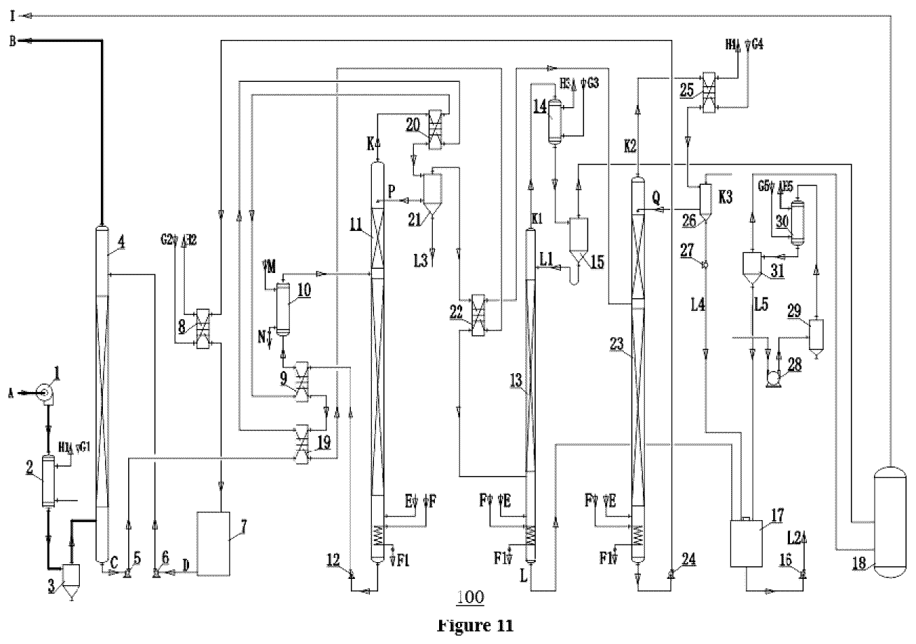

As will be shown in FIG. 10 and FIG. 11, the first target gas processing sub-system 65 and the second target gas processing sub-system 71 may be combined into one target gas processing sub-system. The degasification system may include a first cooler 8 using an external cooling source such as tap water or condensed cold water. The first cooler 8 may be placed along the lean liquid channel 62 only and configured for cooling the lean liquid directly or indirectly flowing out from the first heat exchanger 19, e.g. from the vacuum regeneration tower (23) from its lower segment 23-2.

As will be illustrated in FIG. 10 and FIG. 11, the degasification system 100 may include a heater 10 using an external heat source such as a waste heat medium. The heater 10 may be placed along the rich liquid channel 61 only (i.e. not along the lean liquid channel 62) and between the second heat exchanger 9 and the steaming regeneration tower 11 for heating the rich liquid immediately before it enters the steaming regeneration tower 11.

As will be shown in FIG. 10 and FIG. 11, the degasification system 100 may further include one or more of the following components: (i) a lean liquid tank 7 for storing the lean liquid that has been cooled by the first cooler 8; (ii) a lean liquid pump 6 for pumping the lean liquid stored in the tank 7 up into the upper segment of the degasification tower 4; (iii) a lean liquid pump 12 configured for pumping the lean liquid from the steaming regeneration tower 11 up into an upper segment of the second heat exchanger 9; (iv) a rich liquid pump 5 configured for pumping the rich liquid from the degasification tower 4 up into an upper segment of the first heat exchanger 19; (v) a second cooler 2 using an external cooling source such as tap water or condensed cold water for cooling the raw medium containing the target gas; and (vi) a raw material demister 3. The raw medium containing the target gas that has been cooled by the second cooler 2 may separate into a gas phase containing the target gas and a liquid phase containing condensed water. The gas phase containing the target gas may be introduced into a lower segment of the degasification tower 4.

As will be illustrated in FIG. 10 and FIG. 11, the first target gas processing sub-system 65 may include components with reference numbers 13, 14, 15, 16, 17 and 18. The second target gas processing sub-system 71 may include components with reference numbers 28, 29, 30 and 31.

Preferred embodiments of the present invention provide a “single-stage regeneration decarbonization process and equipment” in which only the steaming regeneration tower 11 is employed for removing the target gas CO₂. Preferred embodiments of the present invention provide a “dual-stage regeneration decarbonization process and equipment” in which both the steaming regeneration tower 11 and the vacuum regeneration tower 23 are employed for removing the target gas CO₂. Two-stage lean liquid/rich liquid heat exchangers (9, 19) are used to ensure complete heat exchange between the lean liquid and rich liquid. Additionally, a gas-liquid heat exchanger or reflux heat exchanger (20) for the mixed gas of carbon dioxide and steam in the hot blend channel 64 and from the steam regeneration tower 11 has been added to significantly improve heat recovery efficiency. In the meantime, the regeneration tower 11 is designed with a lower regeneration section 11-1 and an upper rectification section 11-2, to prevent the active components in a decarbonization liquid (an example of the processing liquid as described above) from being easily carried away, which enhances the stability of decarbonation liquid and reduces operating costs. The vacuum regeneration tower 23 may be added to further regenerate the decarbonization lean liquid after it passes through the steam regeneration tower 11, ensuring more thorough regeneration of the decarbonization lean liquid. The process and equipment have broad industrial applications, suitable for decarbonizing flue gas from thermal power plants, steel sintering gas, converter gas, smelting tail gas, various combustion flue gases, natural gas, coke oven gas, blast furnace gas, chemical feed gases, and various industrial gases or exhaust gases containing CO₂. The total CO₂ content in these gases is less than 99.9% (by volume).

Reference letters/numbers in FIG. 10 are defined in the following: raw gas A, purified gas B, decarbonization rich liquid C, decarbonization lean liquid D, stripping steam E, steam F, distilled water F1, cooling water G1, cooling return water H1, cooling water G2, cooling return water H2, cooling water G3, cooling return water H3, pure carbon dioxide I, CO₂ wet gas K, CO₂ wet gas K1, condensed water L, condensed water L1, condensed water L2, condensed water L3, waste heating medium M (which could be flue gas or other exhaust gases with a temperature greater than 120 °C, or other waste heat mediums or low-pressure residual steam from power generation), medium N (that is from waste medium M after its waste heat has been consumed), reflux liquid P, fan 1, raw gas cooler 2, raw gas demister 3, decarbonization tower 4, dich liquid pump 5, lean liquid pump 6, lean liquid tank 7, cooler 8, second heat exchanger 9, heater 10, regeneration tower 11, regeneration pump 12, enrichment tower 13, cooler 14, demister 15, condensate pump 16, condensate tank 17, buffer tank 18, first liquid heat exchanger 19, gas liquid heat exchanger 20, and first demister 21.

Referring to FIG. 10, the raw gas A (an example of the “raw medium” as described above) is conveyed by fan 1 (when the pressure of A is high enough, fan 1 may not be needed) into the raw gas cooler 2 where it is cooled by cooling water G1. It then enters raw gas demister 3 where mist droplets are removed before the gas flows into decarbonization tower 4 (an example of the “degasification tower 4” as described above). Here, the raw gas A comes into countercurrent contact with the decarbonization lean liquid D sprayed down from the top of the tower 4 to have carbon dioxide absorbed. The raw gas A, from which carbon dioxide has been absorbed, is transformed into purified gas B, which exits from the top of the decarbonization absorption tower 4, to be vented or sent to the next process for further treatment.

After the lean liquid D absorbs carbon dioxide, it is converted into rich liquid C, which collects at the bottom of the decarbonization tower 4. It is then pumped by the rich liquid pump 5 into the first heat exchanger 19 (an example of the “first heat exchanger 19” as described above) where it exchanges heat with the incoming lean liquid D (within the lean liquid channel 62 as described above) from the second heat exchanger 9 (an example of the “second heat exchanger 9” as described above) through rich liquid channel 61 as described above. It then enters the gas-liquid heat exchanger 20 (an example of the “reflux heat exchanger 20” as described above) where it is heated by the CO₂ wet gas K (an example of the “hot blend of target gas and vapor in hot blend channel 64” as described above) flowing out of the top 11-1 of the regeneration tower 11 (an example of the “upper segment 11-1” as described above). The lower part 11-2 of the regeneration tower 11 (an example of the “lower segment 11-2” as described above) is the regeneration section, and the upper part 11-1 is the rectification section. The heated rich liquid C continues to enter the second heat exchanger 9 where it exchanges heat with the hot lean liquid D (within the lean liquid channel 62 as described above) sent by the regeneration pump 12. It then enters the heater 10 where it is further heated by the waste heat medium M (low-pressure steam in this case) to the required temperature for regeneration. It then enters the regeneration section 11-2 of the regeneration tower 11, where it contacts the stripping steam E (low-pressure steam in this case) flowing from the bottom of the regeneration tower 11 in a countercurrent manner. Stripping steam E strips the carbon dioxide from the rich liquid C to form the CO₂ wet gas K, which enters the rectification section 11-1 at the top of the regeneration tower 11.

As described above, at least a part of the liquid phase (for example reflux liquid P as shown in FIG. 10) can flow back (if needed) into the steaming regeneration tower 11 through an inlet located on its upper segment 11-1. In the rectification section 11-1, the reflux liquid P contacts counter-currently with the CO₂ wet gas K, and the reflux liquid P washes the effective components (“active ingredient”) in the CO₂ wet gas K back into the regeneration section 11-2 of the regeneration tower 11. After being washed by the reflux liquid P, the CO₂ wet gas K exits from the top of the regeneration tower 11.

The CO₂-rich liquid C, after releasing carbon dioxide, is converted into lean liquid D, which collects at the bottom of the regeneration tower 11. It is then extracted by the regeneration pump 12 (an example of the “lean liquid pump 12” as described above) and sent to heat exchanger 9 to exchange heat with the rich liquid C coming from the gas-liquid heat exchanger 20. It then enters the first heat exchanger 19 to exchange heat with the rich liquid C delivered by the rich liquid pump 5. After that, it flows into the (first) cooler 8, where it is further cooled to ambient temperature by cooling water G2. It then collects in the lean liquid tank 7. The lean liquid D is then pumped by the lean liquid pump 6 into the decarbonization tower 4 for carbon dioxide absorption, continuing in a continuous cycling operation.

Regarding the first reflux sub-system 66, after the CO₂ wet gas K exits from the top of the regeneration tower 11, it enters the gas-liquid heat exchanger 20 to exchange heat with the rich liquid C coming from the first heat exchanger 19. The CO₂ wet gas K is cooled, and some of the water vapor condenses into water droplets. The CO₂ wet gas K, containing the condensed water droplets, enters the first demister 21 for gas-liquid separation. If needed, the separated condensed water is used as reflux liquid P, entering the rectification section of the upper part 11-1 of the regeneration tower 11. The remaining excess condensed water L3 flows out of the first demister 21 and is recovered into the condensate tank 17. The remaining CO₂ wet gas K flows out of the first demister 21 and enters the bottom of the enrichment tower 13. In the enrichment tower 13, CO₂ wet gas K contacts counter-currently with the condensed water L1 flowing down from the top. Part of the steam condenses into condensed water, which, along with condensed water L1, collects at the bottom of the enrichment tower 13, forming condensed water L. This then flows into the condensate tank 17, collecting as condensed water L2. Finally, the condensed water pump 16 extracts the water for recovery and reuse.

The remaining CO₂ wet gas K1 exits from the top of the enrichment tower 13, then enters the cooler 14, where it is further cooled by cooling water G3. Most of the steam in the CO₂ wet gas K1 condenses into condensed water L1, together with the CO₂ gas to enter the demister 15 for gas-water separation. The separated condensed water L1 continues to flow into the top of the enrichment tower 13, while the pure CO₂ I enters the buffer tank 18 as the product for delivery.

In the system and process as shown in FIG. 10, if the temperature in the regeneration tower 11 is too low to perform regeneration, steam F can be introduced into a steam heater at the bottom of the regeneration tower 11 for indirect heating. Meanwhile, steam F condenses into distilled water F1, which is recovered and sent to the boiler as supplementary soft water. Cooling water G1 is converted into cooling return water H1, cooling water G2 is converted into cooling return water H2, and cooling water G3 is converted into cooling return water H3. After mixing together, the cooling return waters H1, H2, and H3 are sent to the cooling water station for temperature reduction and then converted back into low-temperature cooling water G1, cooling water G2, and cooling water G3 for recycling.

Reference letters/numbers in FIG. 11 are defined in the following: raw gas A, purified gas B, decarbonization rich liquid C, decarbonization lean liquid D, stripping steam E, steam F, distilled water F1, cooling water G1, cooling return water H1, cooling water G2, cooling return water H2, cooling water G3, cooling return water H3, cooling water G4, cooling return water H4, cooling water G5, cooling return water H5, pure CO₂ I, CO₂ wet gas K, CO₂ wet gas K1, CO₂ wet gas K2, CO₂ wet gas K3, condensed water L, condensed water L1, condensed water L2, condensed water L3, condensed water L4, condensed water L5, waste heating medium M (which could be flue gas or other exhaust gases with a temperature greater than 120 °C, or other waste heat mediums or low-pressure residual steam from power generation), medium N (that is from waste medium M after its waste heat has been consumed), reflux liquid P, reflux liquid Q, fan 1, raw gas cooler 2, raw gas demister 3, decarbonization tower 4, rich liquid pump 5, lean liquid pump 6, lean liquid tank 7, cooler 8, second heat exchanger 9, heater 10, regeneration tower 11, regeneration pump 12, enrichment tower 13, cooler 14, demister 15, condensate pump 16, condensate tank 17, buffer tank 18, first heat exchanger 19, first gas liquid heat exchanger 20, first demister 21, second gas-liquid heat exchanger 22, vacuum regeneration tower 23 (lower part 23-2 is vacuum regeneration section, upper part 23-1 is rectification section), vacuum regeneration pump 24, second cooler 25, second demister 26, vacuum condense pump 27, vacuum pump 28, vacuum pump buffer tank 29, third cooler 30, and third demister 31.

Like the system and method as illustrated in FIG. 10, the raw gas A in FIG. 11 is also conveyed by fan 1 (when the pressure of A is high enough, fan 1 may not be needed) into the raw gas cooler 2, where it is cooled by cooling water G1. It then enters raw gas demister 3 where mist droplets are removed before the gas flows into decarbonization tower 4. Here, the raw gas A comes into countercurrent contact with the decarbonization lean liquid D sprayed down from the top of the tower to have carbon dioxide absorbed. The raw gas A, from which carbon dioxide has been absorbed, is transformed into purified gas B, which exits from the top of the decarbonization absorption tower 4, to be vented or sent to the next process for further treatment.

After the lean liquid D absorbs carbon dioxide, it is converted into rich liquid C, which collects at the bottom of the decarbonization tower 4. It is then pumped by the rich liquid pump 5 into the first heat exchanger 19, where it exchanges heat with the incoming lean liquid D from the second heat exchanger 9. It then enters the gas-liquid heat exchanger 20, where it is heated by the CO₂ wet gas K flowing out of the top of the regeneration tower 11 (the lower part 11-2 of the regeneration tower 11 is the regeneration section, and the upper part 11-1 is the rectification section). The heated rich liquid C continues to enter the second heat exchanger 9, where it exchanges heat with the hot lean liquid D sent by the regeneration pump 12. It then enters the heater 10, where it is further heated by the waste heat medium M (low-pressure steam in this case) to the required temperature for regeneration. It then enters the regeneration section 11-2 of regeneration tower 11, where it contacts the stripping steam E (low-pressure steam in this case) flowing from the bottom of the regeneration tower 11 in a countercurrent manner. Stripping steam E strips the carbon dioxide from the rich liquid C to form the CO₂ wet gas K, which enters the rectification section at the top of the regeneration tower 11.

In the rectification section, the reflux liquid P contacts counter-currently with the CO₂ wet gas K, and the reflux liquid P washes the effective components in the CO₂ wet gas K back into the regeneration section of the regeneration tower 11. After being washed by the reflux liquid P, the CO₂ wet gas K exits from the top of the regeneration tower 11.

The CO₂-rich liquid C, after releasing carbon dioxide, is converted into lean liquid D, which collects at the bottom of the regeneration tower 11. It is then extracted by the regeneration pump 12 and sent to the second heat exchanger 9 to exchange heat with the rich liquid C coming from the first gas-liquid heat exchanger 20. It then enters the first heat exchanger 19 to exchange heat with the rich liquid C delivered by the rich liquid pump 5.

Unlike FIG. 10, the lean liquid D in FIG. 11, exiting from the first heat exchanger 19, enters the second gas-liquid heat exchanger 22 (an example of the “pre-vacuum heater 22” as described above), where it is heated by the CO₂ wet gas K coming from the first demister 21. It then enters the vacuum regeneration section 23-2 of the vacuum regeneration tower 23 (the lower section 23-2 is the vacuum regeneration section, and the upper section 23-1 is the rectification section) for further vacuum regeneration. Afterward, it collects at the bottom of the vacuum regeneration tower 23, where it is extracted by the vacuum regeneration pump 24 and sent to cooler 8, where it is further cooled to the ambient temperature by cooling water G2. It then collects in the lean liquid tank 7. The lean liquid D is pumped by the lean liquid pump 6 into the decarbonization tower 4 for carbon dioxide absorption, continuing in a continuous cycling operation.

After the CO₂ wet gas K exits from the top of the regeneration tower 11, it enters the first gas-liquid heat exchanger 20 to exchange heat with the rich liquid C coming from the first heat exchanger 19. The CO₂ wet gas K is cooled, and some of the water vapor condenses into water droplets. The CO₂ wet gas K, containing condensed water droplets, enters first demister 21 for gas-liquid separation. The separated condensed water is used as reflux liquid P and enters the rectification section of the upper part of the regeneration tower 11. The remaining excess condensed water L3 flows out of the first demister 21 and is recovered into the condensate tank 17.

After the remaining CO₂ wet gas K flows out of the first demister 21, it enters the second gas-liquid heat exchanger 22 to exchange heat with the lean liquid D coming from the first heat exchanger 19. It then enters the enrichment tower 13 from the bottom. The CO₂ wet gas K contacts counter-currently with the condensed water L1 flowing down from the top of the enrichment tower 13. Some of the steam condenses into condensed water, which, along with condensed water L1, collects at the bottom of the enrichment tower 13, forming condensed water L. This flows into the condensate tank 17, where it mixes into condensate water L2, and is then extracted by the condensate pump 16 for recovery and reuse.

The CO₂ wet gas K1, containing a small amount of steam, exits from the top of the enrichment tower 13 and enters the cooler 14, where it is further cooled by cooling water G3. Most of the steam in CO₂ wet gas K1 condenses into condensed water L1, together with the CO₂ gas enters demister 15 for gas-water separation. The separated condensed water L1 continues to flow into the top of the enrichment tower 13, while the pure CO₂ I enters the buffer tank 18 as the product for delivery.

The lean liquid D, coming from the second gas-liquid heat exchanger 22, enters the vacuum regeneration section 23-2 of the vacuum regeneration tower 23 for further regeneration, releasing CO₂ wet gas K2. After passing through the rectification section 23-1 of the vacuum regeneration tower 23, it flows out from the top and enters the second cooler 25 (an example of the “reflux cooler 25” as described above) where it is further cooled by cooling water G4. Some of the steam condenses into water droplets, and the CO₂ wet gas K2, containing the condensed water droplets, enters the second demister 26 (an example of the “second demister 26” as described above) for gas-liquid separation. The separated condensed water is used as reflux liquid Q and enters the rectification section of the upper part 23-1 of the vacuum regeneration tower 23, where it washes the effective components (an example of the “active ingredient” as described above) carried by CO₂ wet gas K2 to return to the bottom of the vacuum regeneration tower 23, to mix with the regenerated lean liquid D to prevent the loss of effective components. The remaining excess condensed water L4 flows out from second demister 26, is extracted by the vacuum condensate pump 27, and then sent to the condensate tank 17.

The CO₂ wet gas K3, exiting from the second demister 26, is extracted by the vacuum pump 28 and pressurized. After passing through vacuum pump buffer tank 29, it enters the third cooler 30, where it is further cooled by condensate water G5. Most of the steam in CO₂ wet gas K3 condenses into water droplets, and along with the CO₂ it enters the third demister 31 for gas-water separation. The separated condensed water L5 flows into the condensate tank 17.

The pure CO₂ (I) exiting from the third demister 31 is collected in the buffer tank 18 as a product for delivery. During this process, if the temperature in the regeneration tower 11 is too low to perform regeneration, steam F can be introduced into the heater at the bottom of the regeneration tower 11 for indirect heating. At the same time, steam F condenses into distilled water F1, which is recovered and sent to the boiler as supplementary soft water.

Cooling water G1 is converted into cooling return water H1, cooling water G2 is converted into cooling return water H2, cooling water G3 is converted into cooling return water H3, cooling water G4 is converted into cooling return water H4, and cooling water G5 is converted into cooling return water H5.

After the heated cooling return waters H1, H2, H3, H4, and H5 are mixed together, they are sent to the cooling water station for temperature reduction, where they are converted back into low-temperature cooling waters G1, G2, G3, G4, and G5 for recycling.

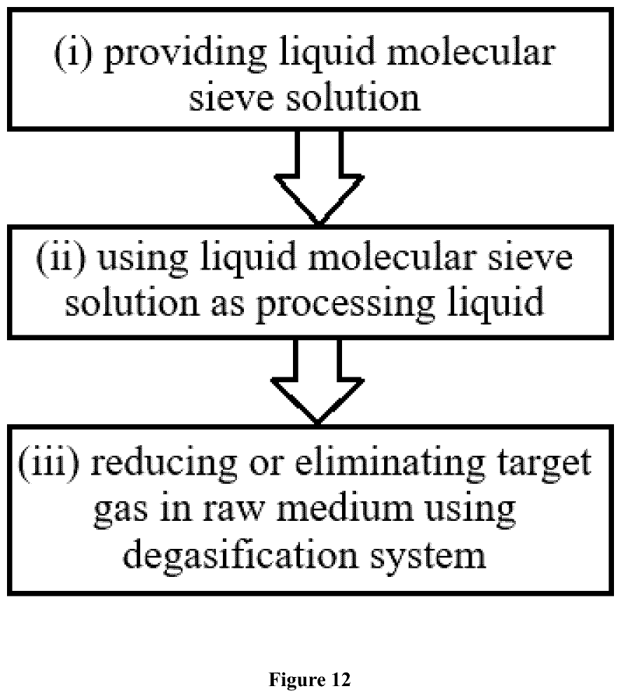

Various embodiments of the invention provide a process of removing a target gas (such as CO₂, SO₂, COS and CS₂) from a raw medium using the degasification system as described above. As schematically illustrated in FIG. 12, the process may include steps of (i) providing a liquid molecular sieve solution; (ii) using the liquid molecular sieve solution as the processing liquid in the degasification system as described above; and (iii) reducing or eliminating the target gas in the raw medium using the degasification system as described above. In preferred embodiments, the process further comprises a step of collecting and recycling the target gas that is separated from the raw medium.

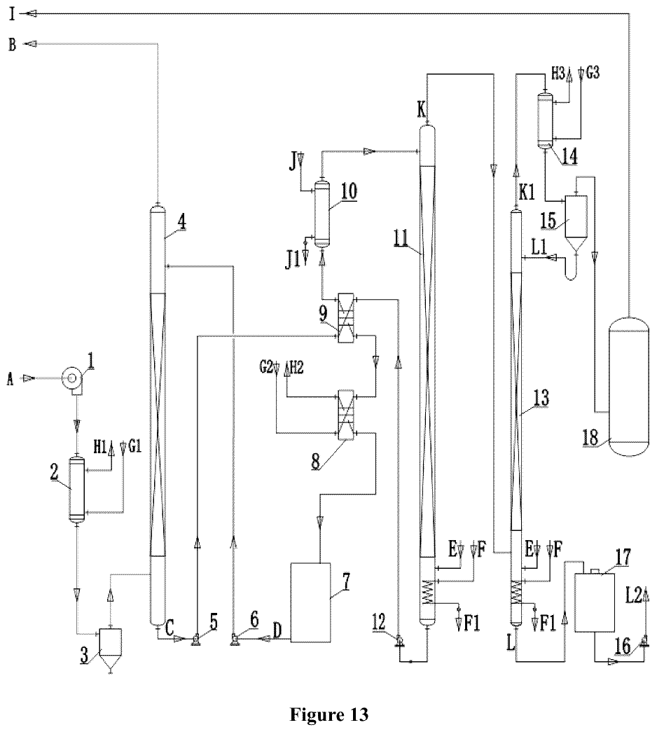

A comparative system and method are also designed and illustrated in FIG. 13. Reference letters/numbers in FIG. 13 are defined in the following: raw gas A, purified gas B, rich liquid C, lean liquid D, stripping steam E, steam F, distilled water F1, cooling water G1, cooling return water H1, cooling water G2, cooling return water H2, cooling water G3, cooling return water H3, pure CO₂ I, steam J, distilled water J1, CO₂ wet gas K, CO₂ wet gas K1, condensate water L, condensate water L1, condensate water L2, fan 1, raw gas cooler 2, raw gas demister 3, decarbonization tower 4, rich liquid pump 5, lean liquid pump 6, lean liquid tank 7, cooler 8, heat exchanger 9, heater 10, regeneration tower 11, regeneration pump 12, enrichment tower 13, cooler 14, demister 15, condensate pump 16, condensate tank 17, and buffer tank 18.

As shown in FIG. 13, the raw gas A is conveyed by fan 1 (when the pressure of A is high enough, fan 1 may not be needed) into the raw gas cooler 2, where it is cooled by cooling water G1. It then enters raw gas demister 3, where mist droplets are removed before the gas flows into decarbonization tower 4. Here, the raw gas A comes into countercurrent contact with the decarbonization lean liquid D sprayed down from the top of the tower to have carbon dioxide absorbed. The raw gas A, from which carbon dioxide has been absorbed, is transformed into purified gas B, which exits from the top of the decarbonization absorption tower 4, to be vented or sent to the next process for further treatment.

After the lean liquid D absorbs carbon dioxide, it is converted into rich liquid C, which collects at the bottom of the decarbonization tower 4. It is then pumped by the rich liquid pump 5 into the second heat exchanger 9, where it exchanges heat with the hot lean liquid D from the regeneration pump 12. The heated rich liquid C enters heater 10, where it is further heated by steam J to the required temperature for regeneration (steam J condenses into distilled water J1, which is recovered and sent to the boiler as supplementary soft water). It then enters regeneration tower 11, where it contacts counter-currently with the stripping steam E coming from the bottom of the regeneration tower 11. The stripping steam E strips the carbon dioxide from the rich liquid C, and the CO₂ wet gas K is formed by the mixing of the stripped CO₂ and steam E, flowing out from the top of the regeneration tower 11.

The rich liquid C, after releasing carbon dioxide, is converted into lean liquid D, which collects at the bottom of the regeneration tower 11. It is extracted by the regeneration pump 12 and sent to the second heat exchanger 9, where it undergoes heat exchange with the rich liquid C brought by the rich liquid pump 5. The lean liquid D is cooled and then enters the cooler 8, where it is further cooled to ambient temperature by cooling water G2. It then collects in the lean liquid tank 7. The lean liquid D is then extracted by the lean liquid pump 6 and sent to the decarbonization tower 4 for CO₂ absorption, continuing the cyclic and continuous operation.

After the CO₂ wet gas K flows out from the top of the regeneration tower 11, it enters the enrichment tower 13 from the bottom. The CO₂ wet gas K contacts counter-currently with the condensed water L1 flowing down from the top of the enrichment tower 13. Some of the steam condenses into condensate water, which, along with the condensed water L1, collects at the bottom of the CO₂ enrichment tower 13, forming condensate water L. This then flows into the condensate tank 17, where it collects into condensate water L2, and is then extracted by the condensate pump 16 for recovery and reuse.

CO₂ wet gas K1 flows out from the top of the enrichment tower 13, then enters the cooler 14, where it is further cooled by cooling water G3. Most of the steam in CO₂ wet gas K1 condenses into condensate water L1, and the CO₂ gas enters the demister 15 for gas-water separation. The separated condensate water L1 continues to flow into the top of the enrichment tower 13, while pure CO₂ I enters the buffer tank 18 as a product for delivery.

In this process of FIG. 13, if the temperature in the regeneration tower 11 is too low to carry out regeneration, steam F can be introduced into the heater at the bottom of the regeneration tower 11 for indirect heating. At the same time, steam F condenses into distilled water F1, which is recovered and sent to the boiler as supplementary soft water.

Cooling water G1 is converted into cooling return water H1, cooling water G2 is converted into cooling return water H2, and cooling water G3 is converted into cooling return water H3. After the cooling return waters H1, H2, and H3 are mixed together, they are sent to the cooling water station for temperature reduction and then converted back into low-temperature cooling waters G1, G2, and G3 for recycling.

The degasification system of FIG. 10 has the following advantages as compared to FIG. 13. First, the process of FIG. 10 can recover a large amount of latent and sensible heat from the CO₂ wet gas K exiting the regeneration tower 11. Second, multiple heat exchanges (e.g. by using the first and second heat exchangers 19 and 9) are used to fully recover the heat from the lean liquid D exiting the regeneration tower. Third, the process utilizes the waste heat from flue gas or exhaust gas, or the waste heat from low-pressure steam after power generation, to further heat the rich liquid C to the regeneration temperature, significantly reduces effective energy consumption. Fourth, the stripping steam E and steam F entering the regeneration tower 11 do not require the use of effective medium- or high-pressure steam but instead use low-pressure steam after power generation. Fifth, the structure of regeneration tower 11 is different from that is FIG. 13. Its lower section functions as a regeneration unit, while the upper section acts as a rectification tower, recovering the effective components back into the lean liquid D. This significantly reduces the loss of effective components in the decarbonization liquid, improves the stability of the decarbonization liquid, and lowers the system operating costs.

The degasification system of FIG. 11 has the following advantages as compared to FIG. 13. First, this process recovers a large amount of latent and sensible heat from the CO₂ wet gas K exiting the regeneration tower 11. Second, multiple heat exchanges (e.g. by using the first and second heat exchangers 19 and 9) are used in FIG. 11 to fully recover the heat from the lean liquid D exiting the regeneration tower. Third, this process utilizes the waste heat from flue gas or exhaust gas, or the waste heat from low-pressure steam after power generation, to further heat the rich liquid C to the regeneration temperature, significantly reduces effective energy consumption. Fourth, the stripping steam E and steam F entering the regeneration tower 11 do not require the use of effective medium- or high-pressure steam but instead use low-pressure steam after power generation. Fifth, the structure of regeneration tower 11 is different from that in FIG. 13. Its lower section functions as a regeneration unit, while the upper section acts as a rectification tower, recovering the effective components back into the lean liquid D. This significantly reduces the loss of effective components in the decarbonization liquid, improves the stability of the decarbonization liquid, and lowers the system operating costs. Sixth, in addition to steam stripping regeneration, a vacuum regeneration system has also been added, making the regeneration of the rich liquid C more thorough. This significantly reduces the carbon dioxide concentration in the regenerated lean liquid D and greatly improves its ability to absorb carbon dioxide. Seventh, the structure of vacuum regeneration tower 23 is different from that in FIG. 13. Its lower section functions for vacuum regeneration, while the upper section serves as a rectification tower, recovering the effective components back into the decarbonization liquid. This significantly reduces the loss of effective components in the decarbonization liquid, improves its stability, and lowers the system operating costs. Eighth, since the vacuum regeneration system is also used, it is easier to control the water content in the decarbonization liquid, preventing the liquid from expanding. At the same time, it further improves the regeneration rate of the decarbonization liquid and enhances the decarbonization performance of the system.

The new gas decarbonization process and equipment of the present invention have wide industrial applications. They can be used for decarbonization of flue gas from thermal power plants, steel sintering furnace gas, converter gas, smelting off-gas, various combustion furnace gases, natural gas, coke oven gas, blast furnace gas, chemical feedstock gases, as well as various industrial feedstock gases or waste gases containing CO₂. The total CO₂ content in these CO₂-containing gases is less than 99.9% (by volume).

The invention will be described in greater detail by way of specific examples. The following examples are offered for illustrative purposes and are not intended to limit the invention in any manner. Those of skill in the art will readily recognize a variety of non-critical parameters that can be changed or modified to yield essentially the same results. Additional compounds within the scope of this invention may be prepared using the methods illustrated in these examples, either alone or in combination with techniques generally known in the art.

### EXAMPLES

To verify some embodiments of the present invention, we have conducted various tests on operational parameters using the following specific implementation plan (pilot-scale experimental plan).

The decarbonization systems as shown in FIG. 10, FIG. 11 and FIG. 13 (comparative) were built. The specifications of the equipment are as follows. Fan 1: Feng Pake 2HB940-HH47 model, power: 25 KW, wind pressure: −310~280 mbar, flow rate: 1940 m³/h. Raw gas cooler 2 specifications: @273 mm×8 mm, total height 4692 mm, pipe φ16 mm×1 mm (L=3500 mm), heat exchange area: 15 m², material: S31603 stainless steel and composite materials. Raw gas demister 3: specifications: 800 mm×4 mm, total height 1000+400 mm, material: S31603 stainless steel. Decarbonization absorption tower 4 specification: φ800 mm×5 mm, total height 10,838 mm, with a layer of 6 m high layer of brushed packing, specific surface area of the packing is 300 m²/m³, material: S31603 stainless steel. Rich liquid pump 5: AJP4462-4025-200, flow rate 0.8~5 m³/h, head H=50 m, motor power 4 KW. Lean liquid pump 6: AJP4462-4025-160, flow rate 0.8~5 m³/h, head H=25 m, motor power 3 KW. Lean liquid tank 7 specifications: φ1000 mm×6 mm, total height 2713 mm, volume 1.85 m³, material S31603 stainless steel. Cooler 8: Plate heat exchanger, 796 mm×320 mm×441 mm, heat exchange area 15 m², material S31603 stainless steel. Heat exchanger 9: Plate heat exchanger, 896 mm×320 mm×545 mm, heat exchange area 30 m², material S31603 stainless steel. Heater 10 specification: φ426 mm×10 mm, total height 4472 mm, tube bundle φ16 mm×1 mm (L=3000 mm), heat exchange area 36.2 m², material S31603 stainless steel and composite materials. Regeneration tower in FIG. 13 specification: tower φ408 mm×4 mm, with a total height of 11850 mm (all are regeneration section, the regeneration section height is 9600 mm), material S31603 stainless steel. Regeneration tower in FIGS. 10-11 specification: tower φ408 mm×4 mm, with a total height of 11850 mm (the height of the lower regeneration section is 9600 mm, and the height of the upper rectification section is 1094 mm), material S31603 stainless steel. Regeneration pump 12: AJP4462-4025-160GW, flow rate: 0.8~5 m³/h, head: H=25 m, motor power: 3 kW. Enrichment tower 13 specifications: 308 mm×4 mm, total height: 7152 mm, material: S31603 stainless steel. Cooler 14 specifications: φ426 mm×10 mm, total height: 3472 mm, tube specifications: φ16 mm×1 mm (L=2000 mm), heat exchange area: 23.8 m², material: S31603 stainless steel and composite materials. Demister 15 specifications: φ800 mm×4 mm, total height: 1000+400 mm, material: S31603 stainless steel. Condense pump 16: AJP4462-25-15, flow rate: 2.5 m³/h, head: H=25 m, motor power: 2.2 kW. Condensate tank 17 specifications: φ800 mm×8, total height 2000 mm, volume 1.00 m³, material: S31603 stainless steel. Buffer tank 18 specification: φ800 mm×4 mm, total height 1458 mm (straight section height 1000 mm), volume 0.65 m³, material S31603 stainless steel. First heat exchanger 19: Plate heat exchanger, dimensions 896 mm×320 mm×545 mm, heat exchange area 30 m², material S31603 stainless steel. Gas-liquid heat exchanger 20: Plate heat exchanger, dimensions 2742 mm×620 mm×1240 mm, heat exchange area 50 m², material S31603 stainless steel. First demister 21 specifications: φ600 mm×4 mm, total height 1700+600 mm, material S31603 stainless steel. Second gas-liquid heat exchanger 22: Plate heat exchanger with specifications of 2742 mm×620 mm×1240 mm, heat exchange area 50 m², material S31603 stainless steel. Vacuum regeneration tower 23 in FIG. 11: the regeneration tower has the specification φ408 mm×4 mm, total height 11850 mm, material S31603 stainless steel. Vacuum regeneration pump 24: AJP4462-4025-160GW, flow rate 0.8~5 m³/h, head H=25 m, motor power 3 kW. Second cooler 25: Plate heat exchanger 2742 mm×620 mm×1240 mm, heat exchange area 50 m², material S31603 stainless steel. Second demister 26: Specification φ600 mm×4 mm, total height 1700+600 mm, material S31603 stainless steel. Vacuum condensate pump 27: AJP4462-25-25, flow rate 0.5 m³/h, head H=25 m, motor power 0.5 kW. Vacuum pump 28: 2BV511, flow rate 230 m³/h, vacuum degree-0.097 MPa, motor power 5.5 kW. Vacuum pump buffer tank 29: Specification φ500 mm×4 mm, total height 1250+240 mm, material S31603 stainless steel. Third cooler 30: Specification 426 mm×10 mm, total height 3472 mm, tube bundle φ16 mm×1 mm (L=2000 mm), heat exchange area 23.8 m², material S31603 stainless steel and composite materials. Third demister 31: Specification φ600 mm×4 mmm, total height 1000+600 mm, material S31603 stainless steel.

Liquid molecular sieves coded as ‘LMSD-CA-P’ and ‘LMSD-CAK-P’ were used as the “processing liquid” described above or as the “decarbonization solution” in these examples to conduct the following experiments by following the three processes shown in FIGS. 10, 11, and 13 and using the above equipment. Flue gas from a natural gas boiler was used as the experimental raw gas A (with a CO₂ concentration of 1.5~25% v/v). Steam after pressure reduction (0.4 MPa, 165 °C) was used the heat source, and cooling water from the cooling tower was used as the circulating cooling water. The degasification system was equipped with a fully automated control system, and the complete experimental process was conducted.

The following parameters were recorded: flow rate of raw gas A (Nm³/h), circulation rate of lean liquid D (m³/h), CO₂ content in raw gas A (% v/v), CO₂ content in purified gas B (% v/v), CO₂ removal efficiency (%), purity of desorbed CO₂(%), CO₂ content in rich liquid C (g/L), CO₂ content in lean liquid D (g/L), regeneration rate of decarbonization solution (%), amount of steam entering heater 10 (J or M) (kg/h), amount of stripping steam E entering regeneration tower 11 (kg/h), amount of heating steam F entering regeneration tower 11 (kg/h), pressure in decarbonization tower 4 (kPa), pressure in regeneration tower 11 (kPa), pressure in vacuum regeneration tower 23 (kPa), temperature in decarbonization tower 4 (°C), temperature of lean liquid D entering cooler 8 (° °C), temperature in regeneration tower 11 (°C), temperature in enrichment tower 13 (° °C), and temperature in vacuum regeneration tower 23 (°C).

The liquid molecular sieve ‘LMSD-CA-P’ was prepared from mixing PEG (polyethylene glycol), MEA (monoethanolamine), and water. The liquid molecular sieve ‘LMSD-CAK-P’ was prepared from mixing PEG (polyethylene glycol), MEA (monoethanolamine), KOH (potassium hydroxide), and water. The experiments were conducted by using the liquid molecular sieves ‘LMSD-CA-P’ and ‘LMSD-CAK-P’ and the results were shown in Table 1 and Table 2, respectively.

TABLE 1
LMSD-CA-P (Average)

| | Process of | Process of | Process of |
|---|---|---|---|
| Results | FIG. 13 | FIG. 10 | FIG. 11 |
| Flow rate of raw gas A (Nm³/h) | 41.37 | 482.30 | 329.63 |
| Circulation rate of lean liquid D (m³/h) | 1.50 | 0.94 | 0.90 |
| CO₂ content in raw gas A (% v/v) | 18.67 | 12.53 | 18.90 |
| CO₂ content in purified gas B (% v/v) | 0.59 | 7.79 | 1.18 |
| CO₂ removal efficiency (%) | 96.82 | 38.52 | 93.15 |
| Purity of desorbed CO₂ (%) | 95.45 | 91.42 | 97.68 |
| CO₂ content in rich liquid C (g/L) | / | 19.63 | 17.98 |
| CO₂ content in lean liquid D (g/L)) | / | 9.76 | 9.15 |
| Regeneration rate of decarbonization solution (%) | / | 47.46 | 46.27 |
| Amount of steam entering heater 10 (J or M) (kg/h) | 141.17 | 37.6 | 31.76 |
| Amount of stripping steam E entering regeneration | 50.6 | 85.18 | 55.51 |
| tower 11 (kg/h) | | | |
| Amount of heating steam F entering regeneration | 0 | 0 | 0 |
| tower 11 (kg/h) | | | |
| Steam consumption for producing 1 ton of CO2 | 13.05 | 2.73 | 0.76 |
| (t/t) | | | |
| Pressure in decarbonization tower 4 (kPa) | 25.75 | 12.6 | 9.04 |
| Pressure in regeneration tower 11 (kPa) | 170.5 | 172.7 | 164.84 |
| Pressure in vacuum regeneration tower 23 (kPa) | / | / | −20.44 |
| Temperature in decarbonization tower 4 (°C) | 33.03 | 35.6 | 35.25 |
| Temperature of lean liquid D entering cooler 8 (°C) | 72.68 | 47.7 | 58.23 |
| Temperature in regeneration tower 11 (°C) | 117.67 | 130.16 | 130.54 |
| Temperature in enrichment tower 13 (°C) | 112 | 126 | 120.94 |
| Temperature in vacuum regeneration tower 23 (°C) | / | / | 37 |

From the data in Table 1, it can be seen that the gas decarbonization experiments using the liquid molecular sieve LMSD-CA-P were conducted in the comparative decarbonization process and equipment (see FIG. 13), the single-stage regeneration decarbonization process and equipment (see FIG. 10), and the dual-stage regeneration decarbonization process and equipment (see FIG. 11), with significantly different results. The operating result of the comparative decarbonization process and equipment (see FIG. 13) showed that 13.05 tons of steam were required to produce 1 ton of carbon dioxide. The operating result of the ‘single-stage regeneration decarbonization process and equipment’ (see FIG. 10) showed that 2.73 tons of steam were required to produce 1 ton of pure carbon dioxide. The operating result of the ‘dual-stage regeneration decarbonization process and equipment’ (see FIG. 11) showed that 0.76 tons of steam was required to produce 1 ton of pure carbon dioxide. The ‘single-stage regeneration decarbonization process and equipment’ (see FIG. 10) and the ‘dual-stage regeneration decarbonization process and equipment’ (see FIG. 11) of the present invention have significant advantages. They have lower energy consumption; they can operate more economically, and produce a higher purity of carbon dioxide.

The results from LMSD-CAK-P are shown in Table 2.

TABLE 2
LMSD-CAK-P (Average)

| | Process of | Process of | Process of |
|---|---|---|---|
| Results | FIG. 13 | FIG. 10 | FIG. 11 |
| Flow rate of raw gas A (Nm³/h) | 212 | 216 | 425.3 |
| Circulation rate of lean liquid D (m³/h) | 1.05 | 1.75 | 1.31 |
| CO₂ content in raw gas A (% v/v) | 14.04 | 10.93 | 5.61 |
| CO₂ content in purified gas B (% v/v) | 3.17 | 1.75 | 0.32 |
| CO₂ removal efficiency (%) | 79.38 | 83.78 | 94.30 |
| Purity of desorbed CO2 (%) | 99.4 | 99.52 | 97.03 |
| CO₂ content in rich liquid C (g/L) | 25.30 | 27.31 | 27.59 |
| CO₂ content in lean liquid D (g/L)) | 6.43 | 9.20 | 7.76 |
| Regeneration rate of decarbonization solution (%) | 74.33 | 66.07 | 71.46 |
| Amount of steam entering heater 10 (J or M) (kg/h) | 81.81 | 45.43 | 32.6 |
| Amount of stripping steam E entering regeneration | 57.3 | 51.0 | 23.8 |
| tower 11 (kg/h) | | | |
| Amount of heating steam F entering regeneration | 0 | 0 | 0 |
| tower 11 (kg/h) | | | |
| Steam consumption for producing 1 ton of CO2 | 3.07 | 2.48 | 1.28 |
| (t/t) | | | |
| Pressure in decarbonization tower 4 (kPa) | 4.10 | 6.6 | 5.6 |
| Pressure in regeneration tower 11 (kPa) | 133.5 | 137.5 | 113.7 |
| Pressure in vacuum regeneration tower 23 (kPa) | / | / | −74.4 |
| Temperature in decarbonization tower 4 (°C) | 44.3 | 30 | 32.2 |
| Temperature of lean liquid D entering cooler 8 (°C) | 69.9 | 71.8 | / |
| Temperature in regeneration tower 11 (°C) | 128.3 | 124.8 | 123.2 |
| Temperature in enrichment tower 13 (°C) | 110.5 | 68.63 | 63.8 |
| Temperature in vacuum regeneration tower 23 (°C) | / | / | 70.1 |

From the data in Table 2, it can be seen that the gas decarbonization experiments using the liquid molecular sieve LMSD-CAK-P were conducted in the comparative decarbonization process and equipment (see FIG. 13), the ‘single-stage regeneration decarbonization process and equipment’ (see FIG. 10), and the ‘dual-stage regeneration decarbonization process and equipment’ (see FIG. 11), with significantly different results.

The operating result of the comparative decarbonization process and equipment (see FIG. 13) showed that 3.07 tons of steam were required to produce 1 ton of pure carbon dioxide. The operating result of the ‘single-stage regeneration decarbonization process and equipment’ (see FIG. 10) showed that 2.48 tons of steam were required to produce 1 ton of pure carbon dioxide. The operating result of the ‘dual-stage regeneration decarbonization process and equipment’ (see FIG. 11) showed that 1.28 tons of steam was required to produce 1 ton of pure carbon dioxide.

The ‘single-stage regeneration decarbonization process and equipment’ (see FIG. 10) and the ‘dual-stage regeneration decarbonization process and equipment’ (see FIG. 11) of the present invention have significant advantages. They have lower energy consumption; they can operate more economically and produce a higher purity of carbon dioxide. In the dual-stage regeneration decarbonization process and equipment from FIG. 11, we have tested the removal of CO₂ from raw gas with a low concentration of carbon dioxide. Its average CO₂ content in the raw gas was 5.61%, the average CO₂ content in the purified gas dropped to 0.32%, the CO₂ removal efficiency reached 94.30%, and the concentration of the produced pure carbon dioxide product reached 97.03%. Accordingly, the steam consumption during regeneration increased relatively, with 1.28 tons of steam required to produce 1 ton of carbon dioxide product. This indicated that, when decarbonizing raw gas with a low concentration of carbon dioxide, if the goal is to improve removal efficiency, the steam consumption also increased accordingly.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. A degasification system for removing a target gas (such as CO₂, SO₂, COS and CS₂) from a raw medium (A) with a processing liquid and regenerating/recycling said processing liquid, comprising:
a degasification tower (4) such as a decarbonization tower configured for receiving the raw medium (A) containing the target gas and a lean liquid as said processing liquid, wherein the lean liquid contacts the raw medium, absorbs the target gas in the raw medium, and is converted into a rich liquid loaded with the target gas;
a steaming regeneration tower (11) configured for receiving a stripping steam (E) and the rich liquid loaded with the target gas from the degasification tower (4), wherein the stripping steam contacts the rich liquid, strips the target gas away from the rich liquid, and converts the rich liquid to a lean liquid for reusing in the degasification tower (4);
a rich liquid channel (61) through which said rich liquid flows from the degasification tower (4) to the steaming regeneration tower (11);
a lean liquid channel (62) through which said lean liquid flows from the steaming regeneration tower (11) back to the degasification tower (4); and
one, two or more heat exchangers 63 (such as 63-1, 63-2 . . . ) placed along both the rich liquid channel 61 and the lean liquid channel 62 and configured for heating the rich liquid while cooling the lean liquid.

2. The degasification system according to claim 1, further comprising a vacuum regeneration tower (23) for further removing residual target gas from the lean liquid flowing out directly from the steaming regeneration tower (11) or flowing out directly from any of said one, two or more heat exchangers (such as 63-1, 63-2); and upgrading the lean liquid to a lean liquid of higher grade before it flows to the degasification tower (4).

3. The degasification system according to claim 1, further comprising a first reflux sub-system (66) mounted onto an upper segment (11-1) of the steaming regeneration tower (11).

4. The degasification system according to claim 2, further comprising a first reflux sub-system (66) mounted onto an upper segment (11-1) of the steaming regeneration tower (11).

5. The degasification system according to claim 2, further comprising a second reflux sub-system (67) mounted to an upper segment (23-1) of the vacuum regeneration tower (23).

6. The degasification system according to claim 2, further comprising a first reflux sub-system (66) mounted onto an upper segment (11-1) of the steaming regeneration tower (11) and a second reflux sub-system (67) mounted to an upper segment (23-1) of the vacuum regeneration tower (23).

7. The degasification system according to claim 6, wherein said one, two or more heat exchangers comprise a first heat exchanger (19) and a second heat exchanger (9);
wherein the first heat exchanger (19) is configured for (A) heating the rich liquid from the degasification tower (4) before the rich liquid flows into the second heat exchanger (9), and (B) cooling the lean liquid from the second heat exchanger (9) before the lean liquid flows back into the degasification tower (4); and
wherein the second heat exchanger (9) is configured for (A) heating the rich liquid from first heat exchanger (19) before the rich liquid flows into the steaming regeneration tower (11), and (B) cooling the lean liquid from the steaming regeneration tower (11) before the lean liquid flows into the first heat exchanger (19).

8. The degasification system according to claim 7, wherein the first reflux sub-system (66) comprises a reflux heat exchanger (20) placed along the rich liquid channel only (i.e. not along the poor liquid channel) and between the first heat exchanger (19) and the second heat exchanger (9), wherein the reflux heat exchanger (20) is configured for further heating the rich liquid from the first heat exchanger (19) before the rich liquid flows into the second heat exchanger (9).

9. The degasification system according to claim 8, wherein the first reflux sub-system (66) comprises a hot blend channel (64),
wherein the steaming regeneration tower (11) produces a hot blend of the target gas and a vapor at its upper segment 11-1, and
wherein the hot blend releases/flows into the reflux heat exchanger (20) through said hot blend channel (64) for heating the rich liquid flowing therethrough while cooling the hot blend itself.

10. The degasification system according to claim 9, wherein the first reflux sub-system (66) comprises a first demister (21); wherein the hot blend from the reflux heat exchanger (20) enters the first demister (21), and separates into a gas phase containing the target gas and a liquid phase containing condensed water and possibly an active ingredient; and wherein a part of the liquid phase flows back into the steaming regeneration tower (11) through an inlet located on its upper segment (11-1).

11. The degasification system according to claim 10, further comprising a first target gas processing sub-system (65) for collecting and disposing of the target gas in the gas phase from the first demister (21); wherein the first reflux sub-system (66) comprises a first gas channel 68 for the gas phase to flow from the first demister (21) into the first target gas processing sub-system (65).

12. The degasification system according to claim 11, further comprising a pre-vacuum heater (22) placed along the lean liquid channel only and configured for heating the lean liquid that has been cooled by the first heat exchanger (19), before the lean liquid flows into vacuum regeneration tower (23).

13. The degasification system according to claim 12, wherein the pre-vacuum heater (22) is configured as a heat exchanger, and the gas phase containing the target gas in the first gas channel 68 is used in the pre-vacuum heater (22) to heat the lean liquid from the first heat exchanger (19), before it is introduced into the first target gas processing sub-system (65) for collecting and disposing of the target gas therein.

14. The degasification system according to claim 13, wherein the second reflux sub-system (67) comprises a reflux cooler (25), a second demister (26), a warm mixture channel (69), and a second gas channel 70 connecting to a second target gas processing sub-system (71);
wherein the reflux cooler (25) is configured for cooling a warm gas mixture from an upper segment (23-1) of the vacuum regeneration tower (23) flowing in the warm mixture channel (69) using any suitable cooling source such as tap water or condensed cold water;
wherein the warm gas mixture that has been cooled by the reflux cooler (25) enters the second demister (26) and separates into a gas phase containing the target gas and a liquid phase containing condensed water and possibly an active ingredient;
wherein at least a part of the liquid phase can flow back into the vacuum regeneration tower 23 on its upper segment 23-1; and
wherein the gas phase containing the target gas in the second demister (26) is released into the second target gas processing sub-system (71) along the second gas channel 70 for collecting and disposing of the target gas in the gas phase.

15. The degasification system according to claim 14, wherein the first target gas processing sub-system 65 and the second target gas processing sub-system 71 are combined into one target gas processing sub-system.

16. The degasification system according to claim 14, further comprising a first cooler (8) using an external cooling source such as tap water or condensed cold water, wherein the first cooler (8) is placed along the lean liquid channel only and configured for cooling the lean liquid indirectly flowing out from the first heat exchanger (19), e.g. from the vacuum regeneration tower (23) from its lower segment.

17. The degasification system according to claim 7, further comprising a heater (10) using an external heat source such as a waste heat medium, wherein the heater (10) is placed along the rich liquid channel (61) only (i.e. not along the lean liquid channel (62)) and between the second heat exchanger (9) and the steaming regeneration tower (11) for heating the rich liquid (immediately) before it enters the steaming regeneration tower (11).

18. The degasification system according to claim 7, further comprising a first cooler (8) using an external cooling source such as tap water or condensed cold water, wherein the first cooler (8) is placed along the lean liquid channel (62) only (i.e. not along the rich liquid channel (61)) and configured for cooling the lean liquid flowing (directly or indirectly) out from the first heat exchanger (19).

19. The degasification system according to claim 18, further comprising:
a lean liquid tank (7) for storing the lean liquid that has been cooled by the first cooler (8), and
a lean liquid pump (6) for pumping the lean liquid stored in the tank (7) up into the upper segment of the degasification tower (4).

20. The degasification system according to claim 7, further comprising a lean liquid pump (12) configured for pumping the lean liquid from the steaming regeneration tower (11) up into an upper segment of the second heat exchanger (9).

21. The degasification system according to claim 7, further comprising a rich liquid pump (5) configured for pumping the rich liquid from the degasification tower (4) up into an upper segment of the first heat exchanger (19).

22. The degasification system according to claim 7, further comprising a second cooler (2) using an external cooling source such as tap water or condensed cold water for cooling the raw medium containing the target gas.

23. The degasification system according to claim 22, further comprising a raw material demister (3), wherein the raw medium containing the target gas that has been cooled by the second cooler (2) separates into a gas phase containing the target gas and a liquid phase containing condensed water; and wherein the gas phase containing the target gas is introduced into a lower segment of the degasification tower (4).

24. A method of removing a target gas (such as CO₂, SO₂, COS and CS₂) from a raw medium using the degasification system according to claim 1, comprising:
(i) providing a liquid molecular sieve solution;
(ii) using the liquid molecular sieve solution as the processing liquid in the degasification system according to claim 1; and
(iii) reducing or eliminating the target gas in the raw medium using the degasification system according to claim 1.

25. The method according to claim 24, further comprising a step of collecting and recycling the target gas that is separated from the raw medium.
